(19) United States
(12) Patent Application Publication
(10) Pub. No.: US 2019/0258289 A1
(43) Pub. Date: Aug. 22, 2019

(54) MOBILE DEVICE

(71) Applicant: Onkyo Corporation, Osaka (JP)

(72) Inventor: Hiroyuki ASAHARA, Osaka (JP)

(21) Appl. No.: 16/257,200

(22) Filed: Jan. 25, 2019

(30) Foreign Application Priority Data
Feb. 20, 2018 (JP) 2018-027994

(51) Int. Cl. G06F 1/16; G06F 3/0488; G06F 3/01; G06F 3/16

(52) U.S. Cl. CPC G06F 1/163; G06F 3/16; G06F 3/017; G06F 3/04883

(57) ABSTRACT

A mobile device comprising: a microphone; an acceleration sensor; a display section; a touch panel; and a controller, wherein the controller sets the display section and the touch panel to ON and enables screen operation when the controller sets the display section and the touch panel to OFF and timing of sound which is collected by the microphone and timing of moving which is detected by the acceleration sensor match.

### CROSS-REFERENCE TO RELATED APPLICATIONS

This application claims priority to Japanese Application No. 2018-027994, filed Feb. 20, 2018, the entire contents of which are incorporated herein by reference.

### FIELD

The present disclosure relates to a wearable type mobile device.

### BACKGROUND

Miniaturization of a mobile device advances, and a so-called wearable type mobile device which is worn on a body of a user comes up. For example, there is a (watch type) mobile device which is worn on an arm of the user (see paragraph 0012 of JP 2017-012277 A.).

In the above-described mobile device which is worn on the arm of the user, there is a device which has a function which starts screen operation by a user with the detection of moving by an acceleration sensor as a trigger. However, there is a problem that it is hard to detect the trigger of start because the arm always moves. Further, it is also required to simplify operation which becomes the trigger.

### SUMMARY OF THE INVENTION

According to one aspect of the disclosure, there is provided a mobile device comprising: a microphone; an acceleration sensor;

a display section; a touch panel; and a controller, wherein the controller sets the display section and the touch panel to ON and enables screen operation when the controller sets the display section and the touch panel to OFF and timing of sound which is collected by the microphone and timing of moving which is detected by the acceleration sensor match.

### BRIEF DESCRIPTION OF THE DRAWINGS

FIG. 1 is a block diagram illustrating a constitution of a mobile device according to an embodiment of the present invention.

FIG. 2 is a flowchart illustrating processing operation of the mobile device in a standby state.

### DETAILED DESCRIPTION OF THE PREFERRED EMBODIMENTS

An objective of the present invention is to be able to enable screen operation by easy user operation without malfunction.

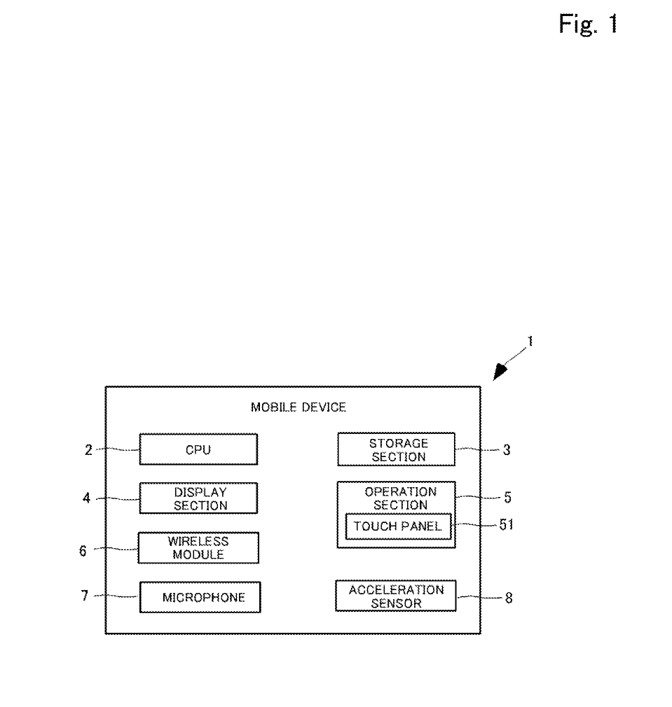

An embodiment of the present invention is described below. FIG. 1 is a block diagram illustrating a constitution of a mobile device according to an embodiment of the present invention. The mobile device 1 is a watch type mobile device and a so-called smart watch. A user wears the mobile device 1 on an arm and uses the mobile device 1. As illustrated in FIG. 1, the mobile device 1 includes a CPU 2, a storage section 3, a display section 4, an operation section 5, a wireless module 6, a microphone 7, and an acceleration sensor 8.

The CPU (Central Processing Unit) 2 (controller) controls respective section composing the mobile device 1 according to a control program, an OS program, and an application program. The storage section 3 is composed of a RAM (Random Access Memory) which functions as a main memory of the CPU 2, a ROM (Read Only Memory) which stores the control program, and a flash memory which stores programs such as the OS program, the application program and so on and various data.

The display section 4 displays various images (including still images and moving images) and is composed of a liquid crystal panel. The operation section 5 includes a touch panel 51 which is linked with the display section 4. The user can perform various characters input, setting and so on via the operation section 5. The wireless module 6 is for performing wireless communication according to Bluetooth (registered trademark) standard and Wi-Fi standard. The microphone 7 collects sound. The acceleration sensor 8 detects moving (vibration) of the mobile device 1.

When the CPU 2 does not receive any operation in a predetermined time by the operation section 5, the CPU 2 sets at least the display section 4 and the touch panel 51 to OFF and sets the mobile device 1 to a standby state. In the standby state, the microphone 7 collects external sound. Sound which is collected by the microphone 7 is output to the CPU 2 as a signal. Further, the acceleration sensor 8 detects moving of the mobile device 1. Moving which is detected by the acceleration sensor 8 is output to the CPU 2 as a signal. When the CPU 2 receives the signal illustrating sound and the signal illustrating moving at the same time, the CPU 2 sets the display section 4 and the touch panel 51 to ON and enables screen operation. Namely, when the CPU 2 sets the display section 4 and the touch panel 51 to OFF and timing of sound which is collected by the microphone 7 and timing of moving which is detected by the acceleration sensor 8 match, the CPU 2 sets the display section 4 and the touch panel 51 to ON and enables screen operation.

For example, when the CPU 2 receives the signal illustrating sound and the signal illustrating moving at the same time three times, the CPU 2 sets the display section 4 and the touch panel 51 to ON and enables screen operation. Namely, when the CPU 2 sets the display section 4 and the touch panel 51 to OFF and timing of sound which is collected by the microphone 7 and timing of moving which is detected by the acceleration sensor 8 match three times, the CPU 2 sets the display section 4 and the touch panel 51 to ON and enables screen operation.

Further, for example, when the CPU 2 receives the signal illustrating sound at a predetermined rhythm and receives the signal illustrating sound and the signal illustrating moving three times at the same time, the CPU 2 sets the display section 4 and the touch panel 51 to ON and enables screen operation. Namely, when timing of sound which is collected by the microphone 7 and timing of moving which is detected by the acceleration sensor 8 match three times and an interval of each time is a predetermined time, the CPU 2 sets the display section 4 and the touch panel 51 to ON and enables screen operation. For example, the user clicks its fingers three times at constant rhythm and hits a table or the like by its hand or finger three times, and the user can enable screen operation. Length of sound (trigger sound) for judging whether screen operation is enabled or not is short sound of not more than a predetermined time. Further, moving for judging whether screen operation is enabled or not is moving of short time not more than a predetermined time.

The user can set number of times and rhythm of trigger sound for enabling screen operation via the operation section 5. The CPU 2 receives setting of number of time and rhythm of trigger sound for enabling screen operation via the operation section 5, and sets received number of times and rhythm.

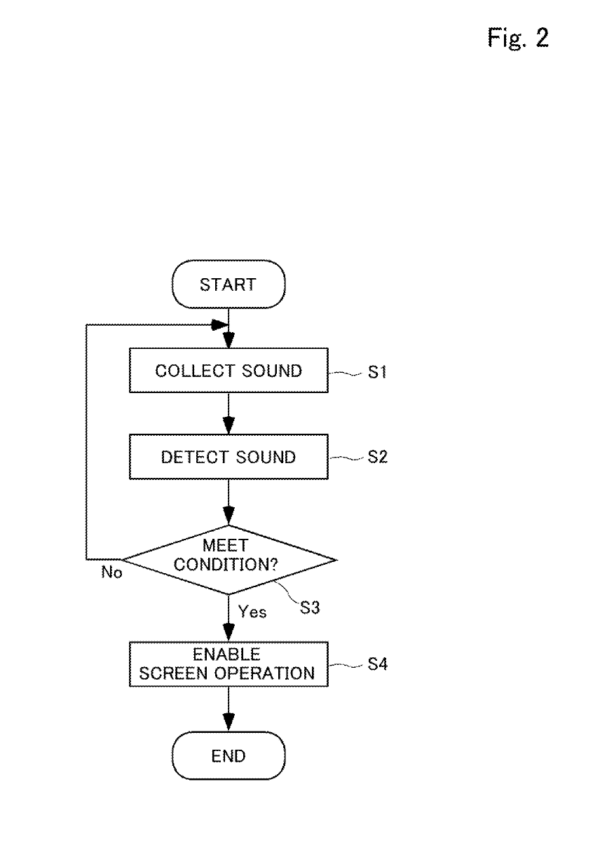

Processing operation of the mobile device 1 in the standby state is described based on a flowchart as illustrated in FIG. 2 below. The microphone 7 collects sound and outputs collected sound as a signal to the CPU 2 (S1). Further, the acceleration sensor 8 detects moving, and outputs detected moving as a signal to the CPU 2 (S2).

The CPU 2 judges whether the received signal illustrating sound and the received signal illustrating moving meet a condition to enable screen operation or not (S3). Namely, the CPU 2 judges whether the CPU 2 receives the signal illustrating sound and the signal illustrating moving at the same time. When the CPU 2 judges that the CPU 2 does not receive the signal illustrating sound and the signal illustrating moving at the same time, the CPU 2 judges that the received signal illustrating sound and the received signal illustrating moving do not meet the condition to enable screen operation. When the CPU 2 judges that the CPU 2 receives the signal illustrating sound and the signal illustrating moving at the same time, the CPU 2 judges whether sound is rhythm and number of times of setting or not. When the CPU 2 judges that sound is rhythm and number of times of setting, the CPU 2 judges that the received signal illustrating sound and the received signal illustrating moving meet condition to enable screen operation. Meanwhile, when the CPU 2 judges that sound is not rhythm and number of times of setting, the CPU 2 judges that the received signal illustrating sound and the received signal illustrating moving do not meet the condition to enable screen operation.

When the CPU 2 judges that the received signal illustrating sound and the received signal illustrating moving meet the condition to enable screen operation (S3: Yes), the CPU 2 sets the display section 4 and the touch panel 51 to ON and enables screen operation (S4). Meanwhile, when the CPU 2 judges that the received signal illustrating sound and the received signal illustrating moving do not meet condition to enable screen operation (S3: No), the CPU 2 ignores sound and moving. In this case, the mobile device 1 is still in the standby state, and processing of S1 to S3 is continuously performed.

As described above, in the present embodiment, when the CPU 2 sets the display section 4 and the touch panel 51 to OFF and timing of sound which is collected by the microphone 7 and timing of moving which is detected by the acceleration sensor 8 match, the CPU 2 sets the display section 4 and the touch panel 51 to ON and enables screen operation. Thus, for example, the user can enable screen operation by simple operation without malfunction because the user wears the mobile device 1 on the arm, the user clicks its fingers (so-called fingers snap), and the user can match generation timing of sound and moving of its arm.

Further, malfunction does not occur because sound is also used to judgement whether to enable screen operation or not in addition to detection of moving.

Further, by detecting moving (vibration) which occurs at the same time with sound, it is possible to identify with the other noise and vibration clearly, for example, because sound that fingers are clicked is sound which is hard to occur in normal life.

Further, the mobile device 1 is a watch type. For this reason, for example, the user wears the mobile device 1 on the arm, clicks fingers, hits a table by finger or hand, and can enable screen operation by simple operation.

Further, SN ratio against surroundings environment sound can be earned and detection ability improves because sound is generated by a hand of the arm on which the mobile device 1 is worn and sound is output to the mobile device 1 from close range. The other arm can be maintained free because operation that generates sound can be perform simply by one hand.

Herein, when timing of sound which is collected by the microphone 7 and timing of moving which is detected by the acceleration sensor 8 match only one time, a case that both timing match by chance is considered. For this reason, when the CPU 2 sets the display section 4 and the touch panel 51 to OFF and timing of sound which is collected by the microphone 7 and timing of moving which is detected by the acceleration sensor 8 match not less than two times, the CPU 2 may set the display section 4 and the touch panel 51 to ON and enables screen operation. Thus, malfunction by chance is prevented. For example, the CPU 2 may not receive setting of one time in setting of number of times of trigger sound.

Further, when the CPU 2 sets the display section 4 and the touch panel 51 to OFF, timing of sound which is collected by the microphone 7 and timing of moving which is detected by the acceleration sensor 8 match not less than two times, and an interval of each time is a predetermined time, the CPU 2 may set the display section 4 and the touch panel 51 to ON and enable screen operation. In this case, further, malfunction is prevented.

The embodiment of the present invention is described above, but the mode to which the present invention is applicable is not limited to the above embodiment and can be suitably varied without departing from the scope of the present invention.

In the above-described embodiment, as a wearable type mobile device, a watch type mobile device is illustrated. Not limited to this, for example, the wearable type mobile device may be a neck band type mobile device which is worn on a neck of a user.

The present invention can be suitably employed in a wearable type mobile device.

What is claimed is:

1. A mobile device comprising:
a microphone;
an acceleration sensor;
a display section;
a touch panel; and
a controller, wherein
the controller sets the display section and the touch panel to ON and enables screen operation when the controller sets the display section and the touch panel to OFF and timing of sound which is collected by the microphone and timing of moving which is detected by the acceleration sensor match.

2. The mobile device according to claim 1, wherein the controller sets the display section and the touch panel to ON and enables the screen operation when the controller sets the display section and the touch panel to OFF and the timing of the sound which is collected by the microphone and the timing of the moving which is detected by the acceleration sensor match not less than two times.

3. The mobile device according to claim 1, wherein the controller sets the display section and the touch panel to ON and enables the screen operation when the controller sets the display section and the touch panel to OFF, the timing of the sound which is detected by the microphone and the timing of the moving which is detected by the acceleration sensor match not less than two times, and an interval of each time is a predetermined time.

4. The mobile device according to claim 1, wherein the mobile device is a watch type.
